(19) United States
(12) Patent Application Publication
(10) Pub. No.: US 2025/0111016 A1
(43) Pub. Date: Apr. 3, 2025

(54) PRODUCTION MANAGEMENT SYSTEM, PRODUCTION MANAGEMENT METHOD, AND RECORDING MEDIUM

(71) Applicant: PANASONIC INTELLECTUAL PROPERTY MANAGEMENT CO., LTD., Osaka (JP)

(72) Inventors: Tatsuaki AMEMURA, Tokyo (JP); Tetsushi OHORI, Tokyo (JP)

(21) Appl. No.: 18/897,442

(22) Filed: Sep. 26, 2024

(30) Foreign Application Priority Data
Oct. 2, 2023 (JP) 2023-171197

(51) Int. Cl. G06F 21/10; G06Q 20/12

(52) U.S. Cl. CPC G06F 21/105; G06Q 20/1235

(57) ABSTRACT

A production management system includes: an obtainer that obtains line configuration information related to an apparatus configuration of a production line including production-related apparatuses used in production of a mounting substrate; an allocator that allocates, to the production-related apparatuses, based on the line configuration information, software licenses that correspond to a plurality of software which, by being executed, realize operations set to the production-related apparatuses, the software licenses being used to permit execution of the plurality of software by the production-related apparatuses; and a displayer that displays a state of the software licenses allocated to the production-related apparatuses.

### CROSS REFERENCE TO RELATED APPLICATION

The present application is based on and claims priority of Japanese Patent Application No. 2023-171197 filed on Oct. 2, 2023.

### FIELD

The present disclosure relates to a production management system, a production management method, and a recording medium.

### BACKGROUND

Patent Literature (PTL) 1 discloses performing a control operation to release a license that is not being used in order to exchange software licenses among a plurality of client terminals.

### CITATION LIST

### Patent Literature

PTL 1: Japanese Unexamined Patent Application Publication No. 2023-4623

### SUMMARY

### Technical Problem

However, when the apparatus configuration of a production line is changed, software licenses need to be re-set according to the change.

In view of this, the present disclosure provides a production management system, and so on, capable of easily setting software licenses according to the apparatus configuration of a production line.

### Solution to Problem

A production management system according to an aspect of the present disclosure includes: an obtainer that obtains line configuration information related to an apparatus configuration of a production line including production-related apparatuses used in production of a mounting substrate; an allocator that allocates, to the production-related apparatuses, based on the line configuration information, software licenses that correspond to a plurality of software which, by being executed, realize operations set to the production-related apparatuses, the software licenses being used to permit execution of the plurality of software by the production-related apparatuses; and a displayer that displays a state of the software licenses allocated to the production-related apparatuses.

Furthermore, a production management method according to an aspect of the present disclosure includes: obtaining line configuration information related to an apparatus configuration of a production line including production-related apparatuses used in production of a mounting substrate; and allocating, to the production-related apparatuses, based on the line configuration information, software licenses that correspond to a plurality of software which, by being executed, realize operations set to the production-related apparatuses, the software licenses being used to permit execution of the plurality of software by the production-related apparatuses.

Furthermore, a production management system according to an aspect of the present disclosure includes: a storage that stores software licenses that correspond to a plurality of software which, by being executed, realize operations set to production-related apparatuses used in production of a mounting substrate, the software licenses being used to permit execution of the plurality of software by the production-related apparatuses; an obtainer that obtains line configuration information related to an apparatus configuration of a production line including the production-related apparatuses; and an allocator that allocates the software licenses to the production-related apparatuses based on the line configuration information.

It should be noted that these generic and specific aspects may be implemented using an apparatus, a system, a method, an integrated circuit, a computer program, or a computer-readable recording medium such as a CD-ROM, or any combination of an apparatus, a system, a method, an integrated circuit, a computer program, or a recording medium.

### Advantageous Effects

The production management system, and so on, according to the present disclosure is capable of easily setting software licenses according to the apparatus configuration of a production line.

It should be noted that the advantages and effects of an aspect of the present disclosure will be made clear in the Specification and Drawings. Each of the advantages and/or effects is provided by a number of features described in the embodiments, Specification, and Drawings. However, all of the features are not necessarily required in order to obtain one or more of the same advantages or effects.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a schematic diagram illustrating a production management system according to an embodiment.

FIG. 2 is a block diagram illustrating the functional configuration of a line management apparatus and a production management apparatus.

FIG. 3 is a diagram illustrating a first example of a UI displayed on a displayer.

FIG. 4 is a diagram illustrating a second example of a UI displayed on the displayer.

FIG. 5 is a diagram illustrating a third example of a UI displayed on the displayer.

FIG. 6 is a diagram illustrating a fourth example of a UI displayed on the displayer.

FIG. 7 is a diagram illustrating a fifth example of a UI displayed on the displayer.

FIG. 8 is a diagram illustrating a sixth example of a UI displayed on the displayer.

FIG. 9 is a diagram illustrating a seventh example of a UI displayed on the displayer.

FIG. 10 is a diagram illustrating an eighth example of a UI displayed on the displayer.

FIG. 11 is a diagram illustrating a ninth example of a UI displayed on the displayer.

FIG. 12 is a diagram illustrating a tenth example of a UI displayed on the displayer.

FIG. 13 is a diagram illustrating an eleventh example of a UI displayed on the displayer.

FIG. 14 is a diagram illustrating a twelfth example of a UI displayed on the displayer.

FIG. 15 is a flowchart illustrating an example of a software license allocation process performed by the production management apparatus.

### DESCRIPTION OF EMBODIMENTS

### Underlying Knowledge Forming Basis of the Present Disclosure

In the production of mounting substrates in a production line used to produce mounting substrates, a plurality of software are used in the production apparatuses. A user changes the software to be used according to the mounting substrate to be produced, and changes the use of software according to an increase or decrease in the production apparatuses included in the production line. For this reason, a plurality of software licenses need to be managed for a plurality of production apparatuses.

Patent Literature 1 discloses performing a control operation to release a license that is not being used in order to exchange software licenses among a plurality of client terminals.

However, software licenses need to be set according to the configuration of the production apparatuses included in the production line. If the user cannot recognize whether a component mounting apparatus is included in the production line, or what software license was allocated to which component mounting apparatus, and so on, it will be difficult for the user to allocate software licenses in such a manner that a desired software is available for use by a desired production apparatus.

In view of this, the inventors have found a production management system as described below that is capable of easily setting software licenses according to the apparatus configuration of a production line.

A production management system according to a first aspect of the present disclosure includes: an obtainer that obtains line configuration information related to an apparatus configuration of a production line including production-related apparatuses used in production of a mounting substrate; an allocator that allocates, to the production-related apparatuses, based on the line configuration information, software licenses that correspond to a plurality of software which, by being executed, realize operations set to the production-related apparatuses, the software licenses being used to permit execution of the plurality of software by the production-related apparatuses; and a displayer that displays a state of the software licenses allocated to the production-related apparatuses.

Accordingly, since the software licenses are allocated to the production-related apparatuses included in the production line based on the line configuration information of the production line, even when the configuration of the production line is changed, software licenses can be allocated according to the changed configuration.

Furthermore, a production management system according to a second aspect of the present disclosure is the production management system according to the first aspect, further including: a storage that stores software licenses held by a user of the production-related apparatuses, and in which, the allocator allocates software licenses from among the software licenses stored in the storage.

For this reason, software licenses that are stored in advance can be allotted to the production-related apparatuses. Furthermore, a production management system according to a third aspect of the present disclosure is the production management system according to the first aspect or the second aspect, in which the displayer displays the software licenses allocated to the production-related apparatuses.

For this reason, the allocated software licenses can be presented to the user.

Furthermore, a production management system according to a fourth aspect of the present disclosure is the production management system according to any one of the first to third aspects, in which the displayer displays a total number of the software licenses held by the user of the production-related apparatuses and a total number of the software licenses allocated to the production-related apparatuses.

For this reason, the number of software licenses held by the user and the number of software licenses allocated to the production-related apparatuses can be presented to the user.

Furthermore, a production management system according to a fifth aspect of the present disclosure is the production management system according to any one of the first to fourth aspects, in which: in response to an update to the production line, the obtainer obtains new line configuration information of the production line updated, and the allocator allocates, to a production-related apparatus added as a result of the update, based on the new line configuration information, a software license that has not been allocated to the production-related apparatuses among the software licenses held by the user of the production-related apparatuses.

For this reason, a software license that has not been allocated can be easily by allocated to an added production-related apparatus.

Furthermore, a production management system according to a sixth aspect of the present disclosure is the production management system according to the fifth aspect, in which, when software licenses for allocation to the production-related apparatuses are lacking in number, the displayer displays information indicating that the software licenses are lacking in number.

For this reason, the fact that software licenses are lacking can be presented to the user.

Furthermore, a production management system according to a seventh aspect of the present disclosure is the production management system according to the fifth aspect or the sixth aspect, in which: the allocator calculates, from the new line configuration information, a total number of software licenses that are lacking for allocation to the production-related apparatuses included in the production line updated, and the displayer displays the total number of software licenses that are lacking.

For this reason, the number software licenses that are lacking can be presented to the user.

Furthermore, a production management system according to an eighth aspect of the present disclosure is the production management system according to any one of the fifth to seventh aspects, in which the displayer displays a first user interface (UI) including a button for accepting a control operation to transition to a purchasing screen for purchasing a software license.

For this reason, the user can be prompted to perform a control operation to transition to a purchasing screen for purchasing a software license.

Furthermore, a production management system according to a ninth aspect of the present disclosure is the production management system according to the eighth aspect, in which the storage stores a total number of licenses purchased via the purchasing screen.

For this reason, management according to the number of software licenses purchased can be performed. For example, the number of software licenses purchased can be added to the number of software licenses that have not been allocated.

Furthermore, a production management system according to a tenth aspect of the present disclosure is the production management system according to the third aspect, in which: in response to an update to the production line, the obtainer obtains new line configuration information of the production line updated, and the allocator cancels, based on the new line configuration information, an allocation of a software license allocated to a production-related apparatus removed from the production line as a result of the update.

For this reason, processing according to the cancellation of the allocation of a software license allocated to a production-related apparatus that has been removed can be easily performed. For example, the number of software licenses whose allocation has been cancelled can be added to the number of software licenses that have not been allocated.

Furthermore, a production management system according to an eleventh aspect of the present disclosure is the production management system according to any one of the first to tenth aspects, in which the production-related apparatuses include any one of a solder printing apparatus that prints solder on a substrate, a component mounting apparatus that mounts a component on the substrate, an inspecting apparatus that inspects the substrate on which the solder has been printed or the substrate on which the component has been mounted, or a support apparatus that supports at least one apparatus among the solder printing apparatus, the component mounting apparatus, or the inspecting apparatus by managing the at least one apparatus or managing production preparation work for the at least one apparatus.

Furthermore, a production management system according to a twelfth aspect of the present disclosure is the production management system according to any one of the first to eleventh aspects, in which: the allocator calculates, based on a total number of software licenses that are lacking for allocation to the production-related apparatuses and a purchasing price associated with the software licenses that are lacking, a shortage amount relative to a payable balance of a user of the production-related apparatuses, and the displayer displays the shortage amount.

Accordingly, since the shortage amount is calculated and presented, it is possible to present the additional fee that is required from the user when the lacking software licenses are to be purchased.

Furthermore, a production management method according to a thirteenth aspect of the present disclosure includes: obtaining line configuration information related to an apparatus configuration of a production line including production-related apparatuses used in production of a mounting substrate; and allocating, to the production-related apparatuses, based on the line configuration information, software licenses that correspond to a plurality of software which, by being executed, realize operations set to the production-related apparatuses, the software licenses being used to permit execution of the plurality of software by the production-related apparatuses.

Accordingly, since the software licenses are allocated to the production-related apparatuses included in the production line based on the line configuration information of the production line, even when the configuration of the production line is changed, software licenses can be allocated according to the changed configuration.

Furthermore, a recording medium according to a fourteenth aspect of the present disclosure is a non-transitory computer-readable recording medium having recorded thereon a program for causing a computer to execute the production management method according to the thirteenth aspect.

Furthermore, a production management system according to a fifteenth aspect of the present disclosure includes: a storage that stores software licenses that correspond to a plurality of software which, by being executed, realize operations set to production-related apparatuses used in production of a mounting substrate, the software licenses being used to permit execution of the plurality of software by the production-related apparatuses; an obtainer that obtains line configuration information related to an apparatus configuration of a production line including the production-related apparatuses; and an allocator that allocates the software licenses to the production-related apparatuses based on the line configuration information.

Accordingly, since the software licenses are allocated to the production-related apparatuses included in the production line based on the line configuration information of the production line, even when the configuration of the production line is changed, software licenses can be allocated according to the changed configuration.

### EMBODIMENT

### [1. Configuration]

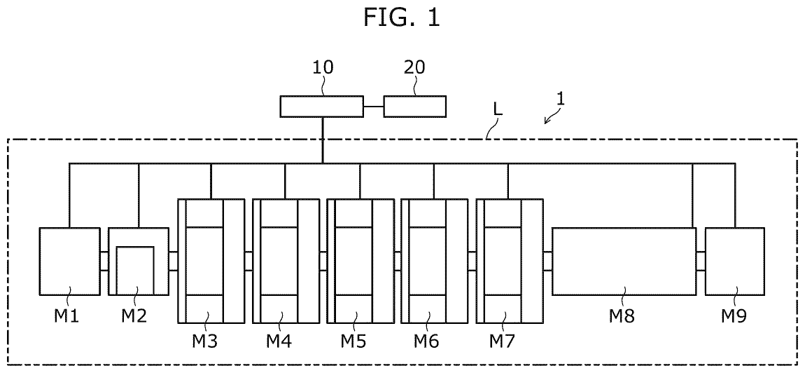

FIG. 1 is a schematic diagram illustrating a production management system according to an Embodiment. Production management system 1 will be described with reference to FIG. 1.

As illustrated in FIG. 1, production management system 1 is a production management system for producing a product. For example, the product is a mounting substrate, which is a substrate on which an electronic component or the like is mounted, a semiconductor, a food or the like. Production management system 1 includes production line L, production management apparatus 10, and line management apparatus 20.

Production management apparatus 10 generates production data for producing a mounting substrate and outputs the production data to production line L. Production management apparatus 10 may communicate with production line L by radio or wire. The radio may be Wi-Fi (registered trademark), Bluetooth (registered trademark), ZigBee, or specified low power radio. Production management apparatus 10 is an example of a support apparatus that supports at least one apparatus among a plurality of production apparatuses M1 to M9 included in production line L by managing production preparation work for the at least one apparatus.

Production line L is a production line for producing a product. For example, when the product is a mounting substrate, production line L is a component mounting line for mounting an electronic component on a substrate. Production line L includes the plurality of production apparatuses M1 to M9.

Each of the plurality of production apparatuses M1 to M9 is a production apparatus for producing a product. A product is produced through a plurality of steps performed by the plurality of production apparatuses M1 to M9. For example, when the product is a mounting substrate, production apparatus M1 is a loader that supplies a substrate to production line L, production apparatus M2 is a solder printing apparatus that prints solder on the substrate. Furthermore, for example, when the product is a mounting substrate, each of a plurality of production apparatuses M3 to M7 is a component mounting apparatus that mounts an electronic component on the substrate, production apparatus M8 is a reflow furnace that melts the solder printed on the substrate, and production apparatus M9 is a loader that discharges the mounting substrate from production line L. Production line L need not include all the plurality of production apparatuses M1 to M9, and may include at least one of the plurality of production apparatuses M1 to M9. Production line L may further include an inspection apparatus that inspects the substrate on which solder has been printed or the substrate on which a component has been mounted.

Line management apparatus 20 is an apparatus that manages each of the plurality of production apparatuses M1 to M9 included in one production line L. Line management apparatus 20 obtains, from production management apparatus 10, production data generated by production management apparatus 10 and causes each working apparatus included in production line L to perform production of a mounting substrate based on the production data. Line management apparatus 20 is an example of a support apparatus that supports at least one apparatus among the plurality of production apparatuses M1 to M9 included in production line L by managing the at least one apparatus.

For example, production line L may include one production apparatus, rather than a plurality of production apparatuses. Furthermore, for example, production management system 1 may include a plurality of production lines L, rather than one production line L. When production management system 1 includes a plurality of production lines L, production management system 1 may include a plurality of line management apparatuses 20 for managing production lines L.

Production management apparatus 10, line management apparatus 20, and the plurality of production apparatuses M1 to M9 are examples of a plurality of production-related apparatuses used for production of a mounting substrate.

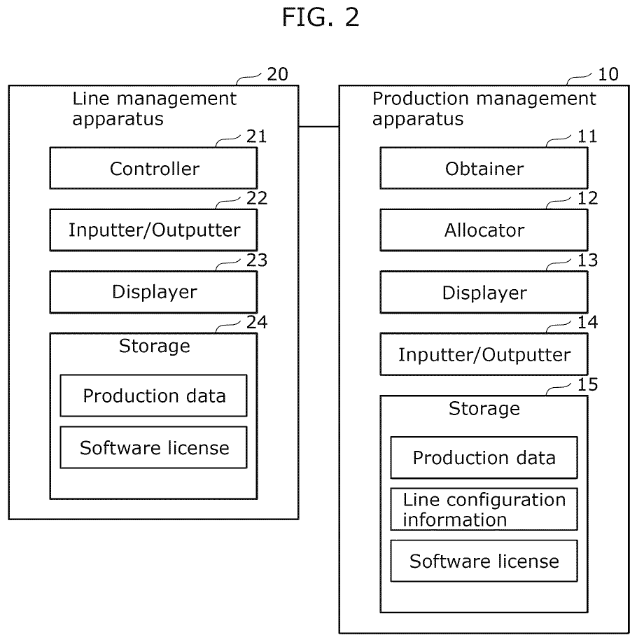

FIG. 2 is a block diagram illustrating a functional configuration of the line management apparatus and the production management apparatus.

Production management apparatus 10 includes obtainer 11, allocator 12, displayer 13, inputter/outputter 14, and storage 15.

Obtainer 11 obtains line configuration information related to an apparatus configuration of production line L. Obtainer 11 may obtain line configuration information at regular intervals. Accordingly, when the apparatus configuration of production line L is updated, obtainer 11 may obtain new line configuration information of updated production line L upon update of production line L. Update of the apparatus configuration of production line L means that any one apparatus among the plurality of production apparatuses M1 to M9 included in production line L is omitted (removed) or that a production apparatus is newly added to production line L. Update of the apparatus configuration of production line L may also mean that software or hardware of any one apparatus among the plurality of production apparatuses M1 to M9 included in production line L is upgraded or downgraded.

The line configuration information includes information indicating the plurality of production apparatuses M1 to M9 included in production line L. The line configuration information also includes information related to software executed by each of the plurality of production apparatuses M1 to M9.

Allocator 12 allocates a plurality of software licenses to the plurality of production apparatuses M1 to M9 based on the line configuration information. The plurality of software licenses allocated by allocator 12 are software licenses stored in storage 15. That is, allocator 12 determines software licenses to be allocated to the plurality of production apparatuses M1 to M9 among a plurality of software licenses that are stored in storage 15 and thereby indicated as being held by a user. Furthermore, when the apparatus configuration of production line Lis updated and obtainer 11 obtains new line configuration information, allocator 12 may allocate, to a production apparatus newly added as a result of the update based on the new line configuration information, a software license that has not been allocated to the plurality of production apparatuses in the new apparatus configuration from among the plurality of software licenses held by the user. Furthermore, allocator 12 may cancel, based on the new line configuration information, an allocation of a software license allocated to a production apparatus removed as a result of the update.

Furthermore, allocator 12 determines, from the new line configuration information, whether or not software licenses are lacking for allocation to the plurality of production apparatuses included in the updated production line. When it is determined that software licenses for allocation are lacking in number, allocator 12 may calculate a total number of software licenses that are lacking for allocation.

Here, software license corresponds to each of a plurality of software that realize a plurality of operations set to each production apparatus. That is, a production apparatus can perform a plurality of operations, and each operation is realized by software corresponding to the operation. Execution of each software is permitted by allocation of a software license corresponding to the software. That is, the software license is used to permit execution of the corresponding software by the production apparatus in which the software is installed. The software may be software that supports preparation of production for the production apparatus or software for managing the production apparatus.

Furthermore, allocator 12 may calculate, based on the total number of software licenses that are lacking for allocation to the plurality of production apparatuses M1 to M9 and a purchasing price associated with the software licenses that are lacking, a shortage amount relative to a payable balance of the user. Here, the payable balance of the user means the balance that can be used for payment by the user to purchase the software licenses, and can be increased by the user depositing money into the account set for the user.

Displayer 13 displays states of software licenses allocated to the plurality of production apparatuses M1 to M9. For example, displayer 13 displays information that indicates, for each of the plurality of production apparatuses M1 to M9, to which software a software license has been allocated. Displayer 13 may also display software licenses allocated to the plurality of production apparatuses M1 to M9. Displayer 13 may also display the number of software licenses held by the user of the plurality of production apparatuses M1 to M9 and the number of software licenses that have been allocated to the plurality of production apparatuses M1 to M9. When software licenses are lacking for allocation to the plurality of production apparatuses M1 to M9, displayer 13 may display information that indicates that software licenses are lacking for allocation. Displayer 13 may also display the total number of software licenses that are lacking for allocation. Displayer 13 may also display a first user interface (UI) including a button for accepting a control operation to transition to a purchasing screen for purchasing a software license. Displayer 13 may also display a shortage amount relative to the payable balance calculated by allocator 12.

Inputter/outputter 14 accepts input data based on a control operation by an operator of production management system 1, for example, and outputs the input data to allocator 12. Such inputter/outputter 14 includes a keyboard, a touch sensor, a touch pad, or a mouse, for example. Inputter/outputter 14 performs output of data to production line L and input of data from production line L. The production data stored in storage 15 may be output to production line L via inputter/outputter 14.

Storage 15 stores the production data described above. Storage 15 also stores the line configuration information obtained by obtainer 11. Storage 15 also stores software licenses used by the plurality of production apparatuses M1 to M9 included in production line L. Here, the software licenses stored are software licenses held by the user of the plurality of production apparatuses M1 to M9.

Storage 15 may store the number of software licenses that have been allocated to the plurality of production apparatuses M1 to M9 and the number of software licenses that have not been allocated among a plurality of software licenses. When allocation of a software license to a production apparatus removed as a result of an update is cancelled, the number of software licenses that have been allocated is decreased by the number of software licenses whose allocation to production apparatuses have been cancelled. At the same time, the number of software licenses that have not been allocated is increased by the number of software licenses whose allocation to a production apparatus has been cancelled. That is, the number of software licenses that have been allocated to the plurality of production apparatuses M1 to M9 and the number of software licenses that have not been allocated are updated as production line L is updated.

Storage 15 may also store the number of software licenses purchased. In this case, the number of software licenses that have not been allocated is increased by the number of software licenses purchased.

Line management apparatus 20 includes controller 21, inputter/outputter 22, displayer 23, and storage 24.

Controller 21 controls the plurality of production apparatuses M1 to M9 included in production line L, which is a target of management of line management apparatus 20. Controller 21 controls operation of each working apparatus included in production line L, thereby causing the working apparatus to perform production of a mounting substrate based on production data.

Inputter/outputter 22 accepts input data based on a control operation by an operator of production management system 1, for example, and outputs the input data to controller 21. Such inputter/outputter 22 includes a keyboard, a touch sensor, a touch pad, or a mouse, for example. Inputter/outputter 22 performs output of data to production management apparatus 10 and input of data from production management apparatus 10. For example, inputter/outputter 22 obtains production data from production management apparatus 10 and stores the production data in storage 24.

Displayer 23 displays production data or the like retained in storage 24. Specific examples of displayer 23 includes a liquid crystal display, a plasma display, or an organic-EL display, for example. However, displayer 23 is not limited to these.

Storage 24 stores production data. Storage 24 also store software licenses used by the plurality of production apparatuses M1 to M9 included in production line L.

### [2. Example Display Screens]

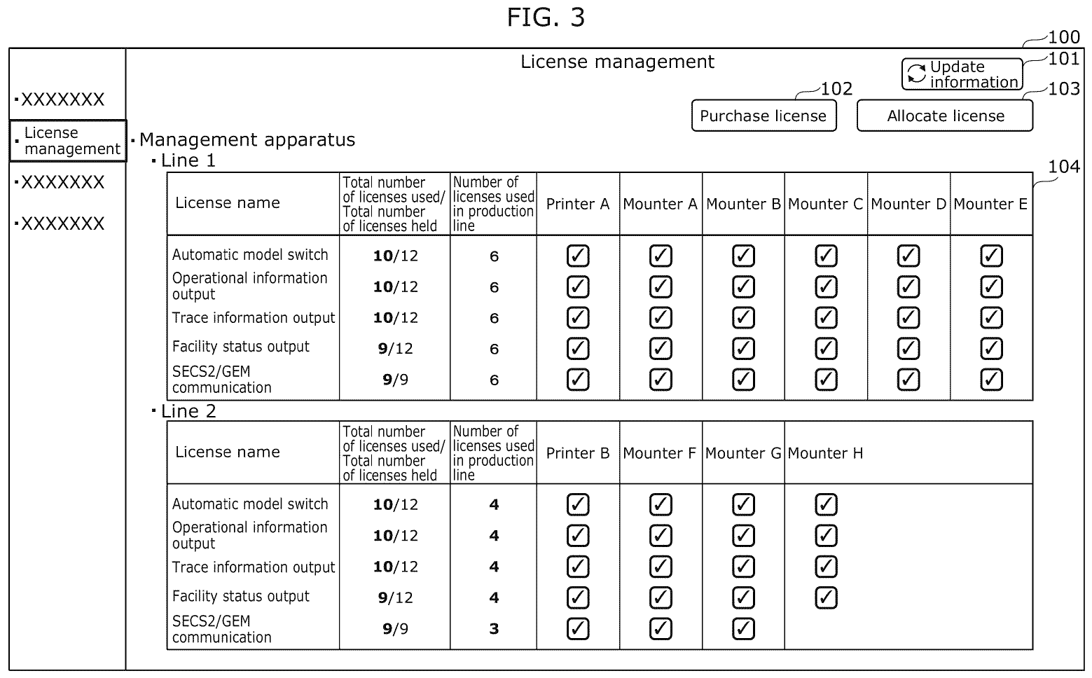

The UI illustrated in FIG. 3 to FIG. 14 will be described.

As illustrated in FIG. 3, displayer 13 displays UI 100.

UI 100 includes information for managing software licenses. UI 100 includes update button 101 for updating information for managing software licenses, purchase button 102 for purchasing software licenses, allocation button 103 for allocating software licenses, and license information 104 including allocation information that indicates which software license is allocated to which production apparatus.

UI 100 includes license information 104 on a production line basis. License information 104 includes license name, total number of licenses used/total number of licenses held, number of licenses used in production line, and allocation information.

The license name indicates license name of a plurality of types of software licenses. Among the total number of licenses used/total number of licenses held, the total number of licenses used indicates the number of software licenses used for each type of software licenses. The total number of licenses used indicates the number of software licenses used by the plurality of production apparatuses M1 to M9 included in production management system 1, and when there are a plurality of production lines, the total number of licenses used indicates the number of software licenses used by the production apparatuses included in the plurality of production lines. The total number of licenses held indicates the number of software licenses held by the user for each type of software licenses. The number of licenses used in production line indicates the number of associated software licenses used in a production line. The allocation information indicates, for pairs of a plurality of production apparatuses and a plurality of types of software licenses, whether associated types of software license have been allocated to production apparatuses. The allocation information includes a check box for each pair. If a check box for a pair is checked with a check mark, it indicates that the type of software license of the pair has been allocated to the production apparatus of the pair. If no check box is shown for a pair, it indicates that the type of software license of the pair has not been allocated to the production apparatus of the pair. Although the allocation information has been described as including no check box for a pair for which no software license has been allocated, the allocation information is not limited to this, but may include a check box that is not checked with a check mark.

UI 100 is generated based on the line configuration information. UI 100 is generated when a predetermined control operation is accepted from the user. The predetermined control operation may be a control operation to display UI 100 or an input to update button 101. UI 100 is displayed on displayer 13 when UI 100 is generated. When an input to update button 101 occurs, UI 100 is generated based on line configuration information obtained when the input to update button 101 occurs, and generated UI 100 is displayed on displayer 13. Purchase button 102 and allocation button 103 will be described later.

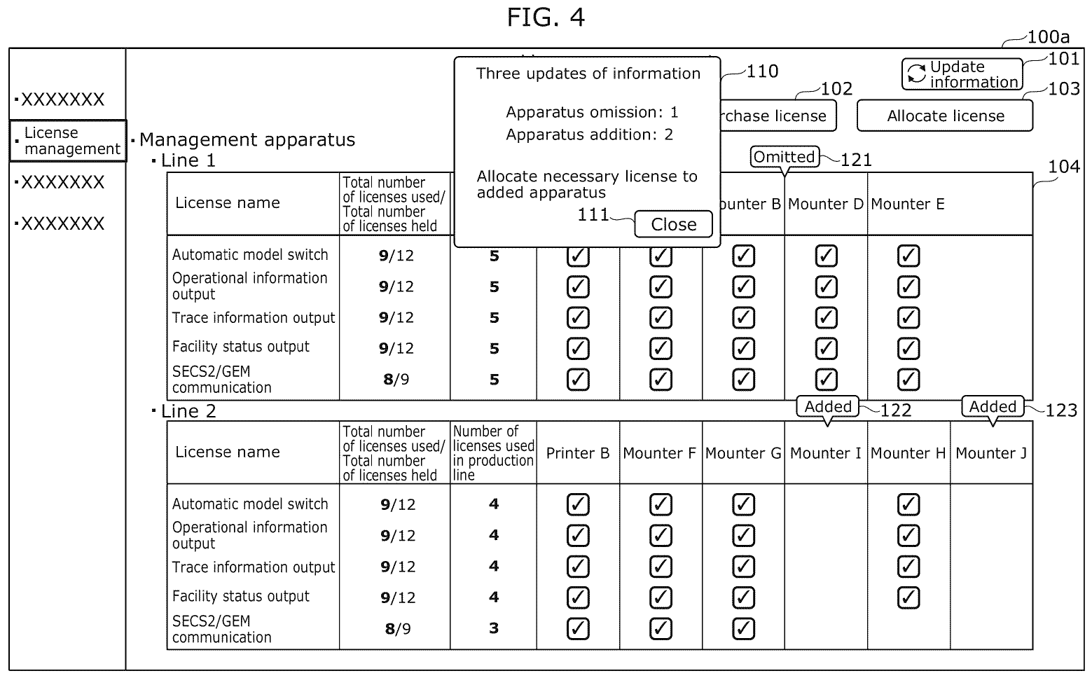

When production management apparatus 10 accepts an input to update button 101, UI 100 is updated to UI 100a as illustrated in FIG. 4. UI 100a includes UI 110 that indicates that production line L has been updated when new UI 100 is generated from new line configuration information that is different from the line configuration information for UI 100 previously displayed. UI 110 includes a message that indicates that the apparatus configuration of production line L has been updated and close button 111 for closing UI 110. For example, when mounter C is omitted from line 1 and mounter I and mounter J are added to line 2, UI 110 includes a message that indicates one apparatus has been omitted and two apparatuses have been added.

UI 110a is an UI generated by adding, to UI 100, icon 121 that indicates that mounter C has been omitted from line 1 and icons 122 and 123 that indicates that mounter I and mounter J have been added to line 2.

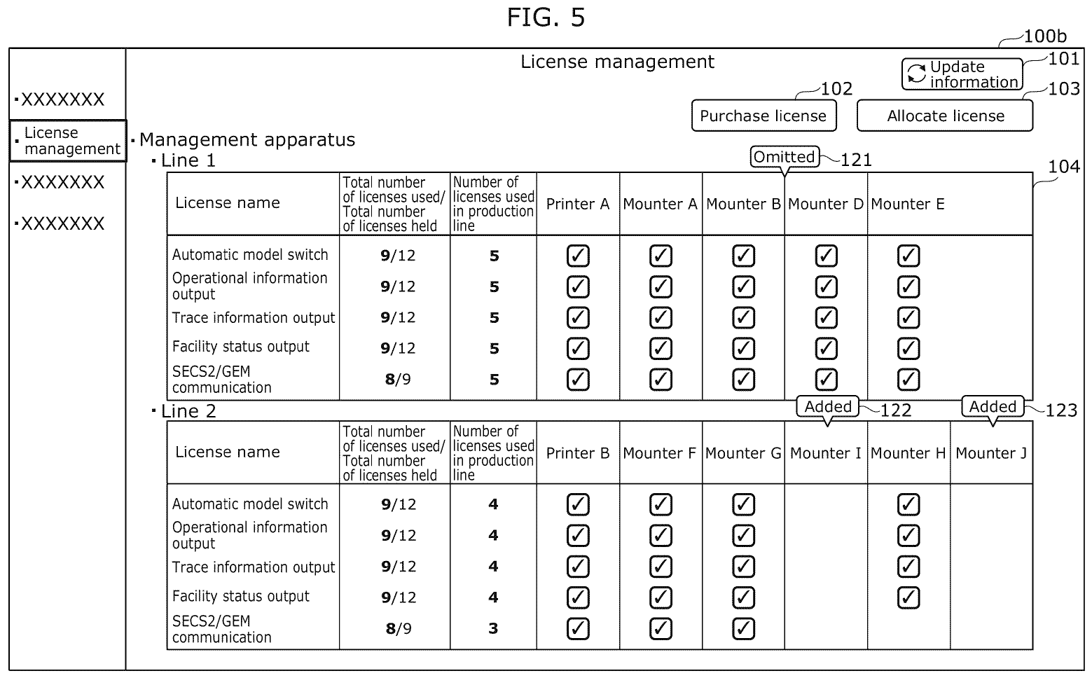

When production management apparatus 10 then accepts an input to the close button in UI 110, UI 100a is updated to UI 100b without UI 110 as illustrated in FIG. 5.

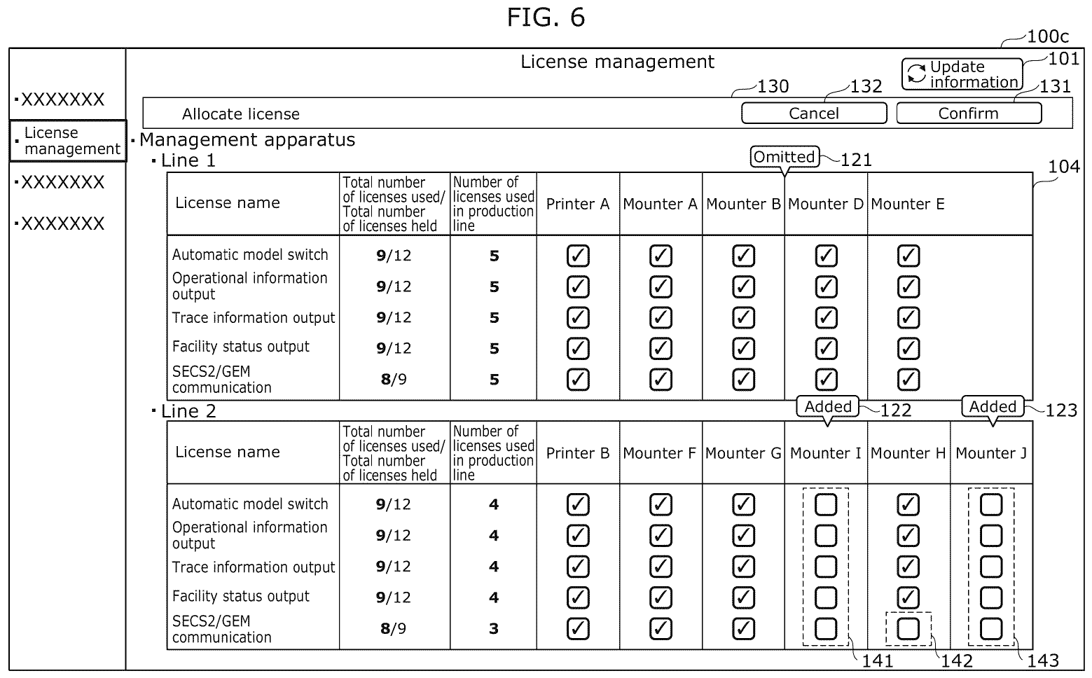

When an input to allocation button 103 in UI 100b is then accepted, the UI displayed on displayer 13 is updated to UI 100c that includes box 130 for performing processing of allocating a software license and check boxes 141 to 143, as illustrated in FIG. 6. Box 130 includes a message that indicates that UI 100c accepts, from the user, an input to allocate a software license, confirmation button 131, and cancel button 132. Confirmation button 131 is a button for confirming a change of allocation of a software license. When production management apparatus 10 accepts an input to confirmation button 131, software licenses are allocated to production apparatuses in accordance with the check marks in the check boxes. Cancel button 132 is a button for transitioning from UI 100c to UI 100b. When production management apparatus 10 accepts an input to cancel button 132, the UI displayed on displayer 13 transitions from UI 100c to UI 100b. Check boxes 141 indicate, for pairs of mounter I, which is a production apparatus added as a result of an update of the apparatus configuration of production line L, and a plurality of types of software licenses, whether associated types of software license have been allocated to the production apparatus, and check boxes 143 indicate, for pairs of mounter J, which is also a production apparatus added as a result of the update of the apparatus configuration of production line L, and a plurality of types of software licenses, whether associated types of software licenses have been allocated to the production apparatus. Check boxes 141 and 143 correspond to the added production apparatuses and include no check marks since no software licenses have been allocated to the added production apparatuses. Check box 142 is a check box that corresponds to a pair including mounter H, which has been included in line 2 before the update, for which no software license has been allocated. Check box 142 may be normally displayed, rather than being displayed when an input to allocation button 103 is accepted. That is, check box 142 may be included in UI 100, UI 100a, or UI 100b.

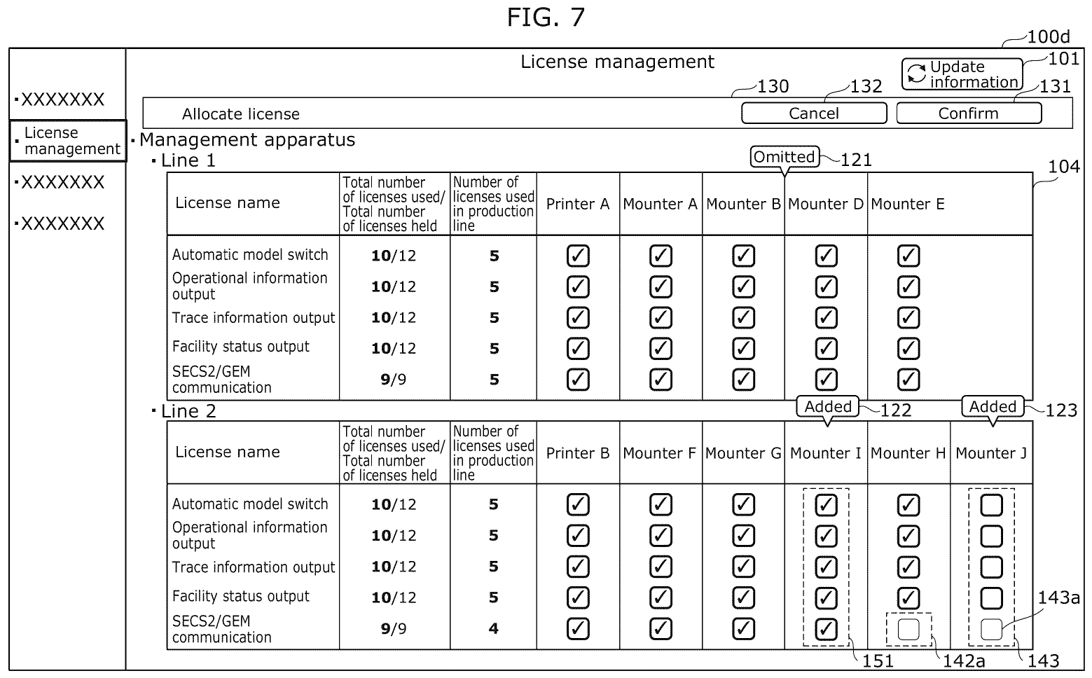

When production management apparatus 10 accepts an input to check boxes 141 corresponding to mounter I in UI 100c, check boxes 141 corresponding to automatic model switch, operational information output, trace information output, facility status output, and SECS/GEM communication are modified to check boxes 151 with check marks, as illustrated in FIG. 7. That is, the UI displayed on displayer 13 is updated from UI 100c to UI 100d. Accordingly, the total number of licenses used/total number of licenses held and the number of licenses used in production line for line 2 in license information 104 are updated. The total number of licenses used/total number of licenses held and the number of licenses used in production line for line 2 are modified by the increment of the check boxes with check marks for each software license. For example, the total number of licenses used/total number of licenses held is modified from “9/12” to “10/12” for the software licenses for automatic model switch, operational information output, trace information output, and facility status output, and is modified from “8/9” to “9/9” for the software license for SECS/GEM communication. At this time, the total number of licenses used/total number of licenses held for the software license for SECS/GEM communication is “9/9”, which means that the total number of licenses held are used. Therefore, check box 142a that corresponds to the software license for SECS/GEM communication for mounter H and check box 143a that license corresponds to the software for SECS/GEM communication for mounter J are unavailable and modified to an appearance that indicates the unavailability. For example, check boxes 142a and 143a are shown by a thinner line than the available check boxes. Check boxes 142a and 143a may be deleted to indicate that the check boxes are unavailable, or may be grayed out to indicate that the check boxes are unavailable. The number of licenses used in production line for line 2 is modified from “4” to “5” for the software licenses for automatic model switch, operational information output, trace information output, and facility status output, and is modified from “3” to “4” for the software license for SECS/GEM communication, for example.

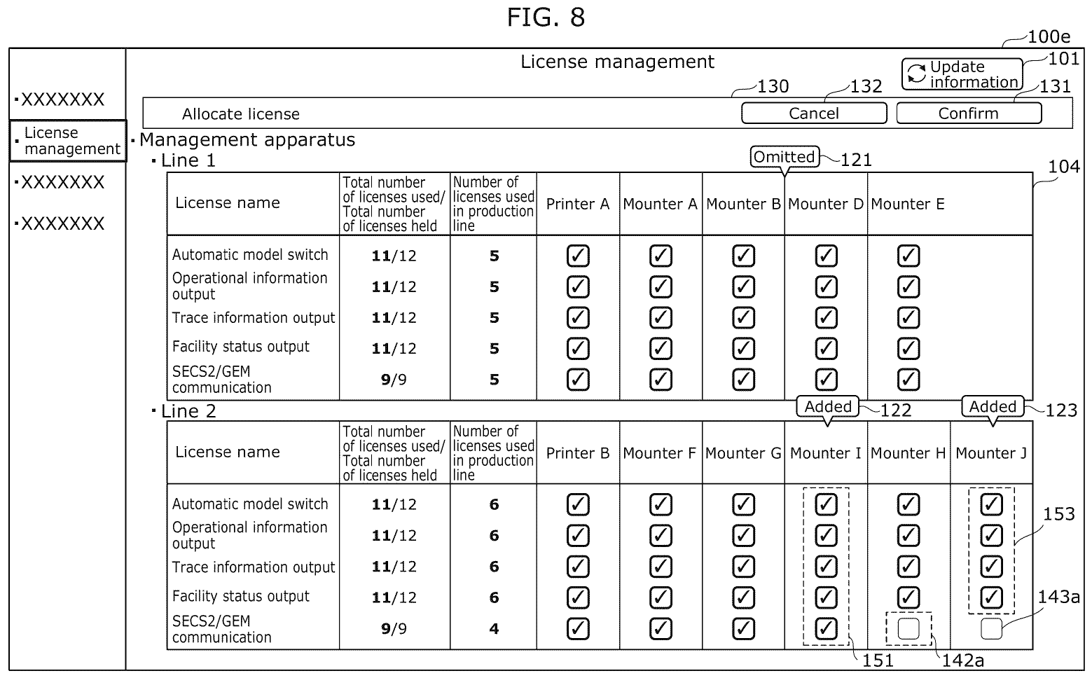

When production management apparatus 10 accepts inputs to the check boxes that correspond to automatic model switch, operational information output, trace information output, and facility status output for mounter J among check boxes 143 in UI 100d, the check boxes that correspond to automatic model switch, operational information output, trace information output, and facility status output are modified to check boxes 153 with check marks, as illustrated in FIG. 8. That is, the UI displayed on displayer 13 is updated from UI 100d to UI 100e. Accordingly, at this time, the total number of licenses used/total number of licenses held and the number of licenses used in production line for line 2 in license information 104 are updated. The total number of licenses used/total number of licenses held and the number of licenses used in production line for line 2 are modified by the increment of the check boxes with check marks for the software licenses. For example, the total number of licenses used/total number of licenses held is modified from “10/12” to “11/12” for the software licenses for automatic model switch, operational information output, trace information output, and facility status output. The number of licenses used in production line for line 2 is modified from “5” to “6” for the software licenses for automatic model switch, operational information output, trace information output, and facility status output, for example.

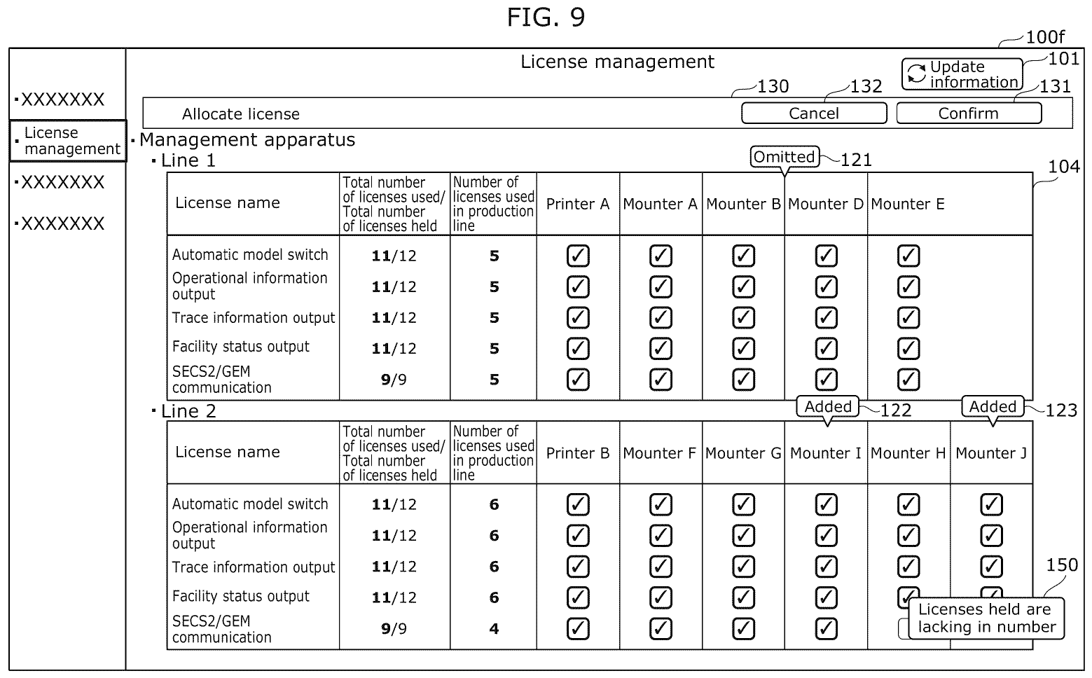

When production management apparatus 10 accepts an input to check box 143a, which is unavailable, in UI 100e, the UI is modified to UI 100f, which includes message 150 that indicates that check box 143a is unavailable, as illustrated in FIG. 9. For example, when production management apparatus 10 accepts a control operation to indicate allocation of another software license, production management apparatus 10 compares the total number of licenses used with the total number of licenses held, and displays, on displayer 13, message 150 that indicates that the software licenses for allocation will be lacking in number when the total number of licenses used and the total number of licenses held are equal to each other.

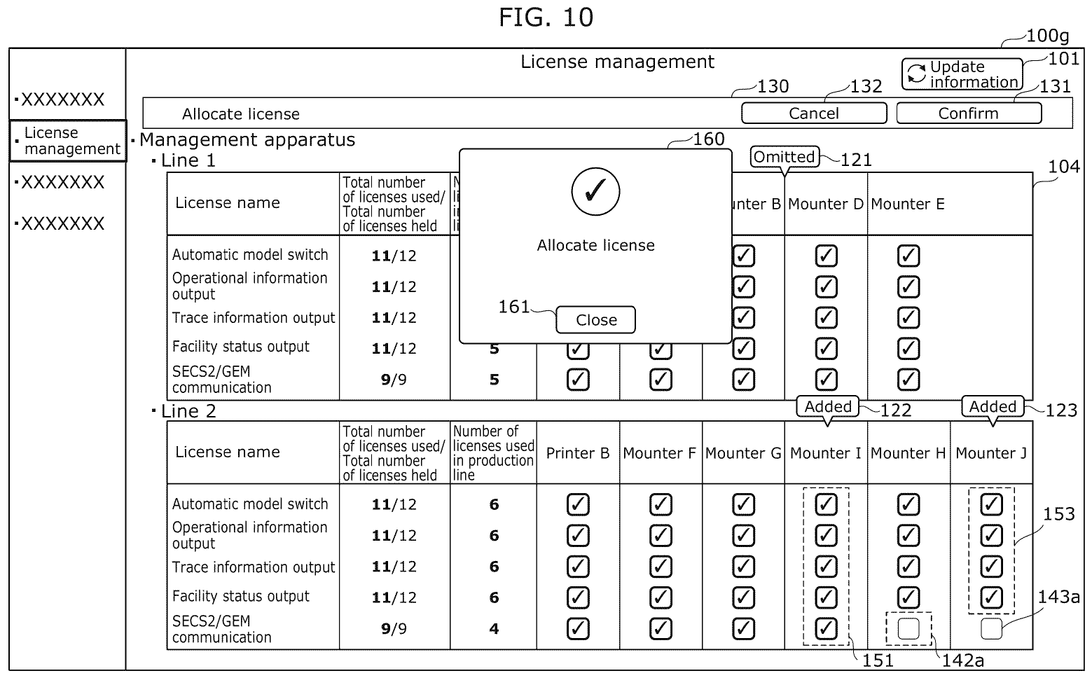

When production management apparatus 10 accepts an input to confirmation button 131 in UI 100e or UI 100f, the UI displayed on displayer 13 is updated to UI 100g, in which allocation of software licenses is performed according to the contents indicated by check boxes 151 and 153 updated in UI 100e or UI 100f and which includes UI 160 that indicates the allocation has been performed, as illustrated in FIG. 10. UI 160 includes a message that indicates that allocation of software licenses has been performed according to the contents indicated by check boxes 151 and 153 updated in UI 100e or UI 100f and close button 161 for closing UI 160.

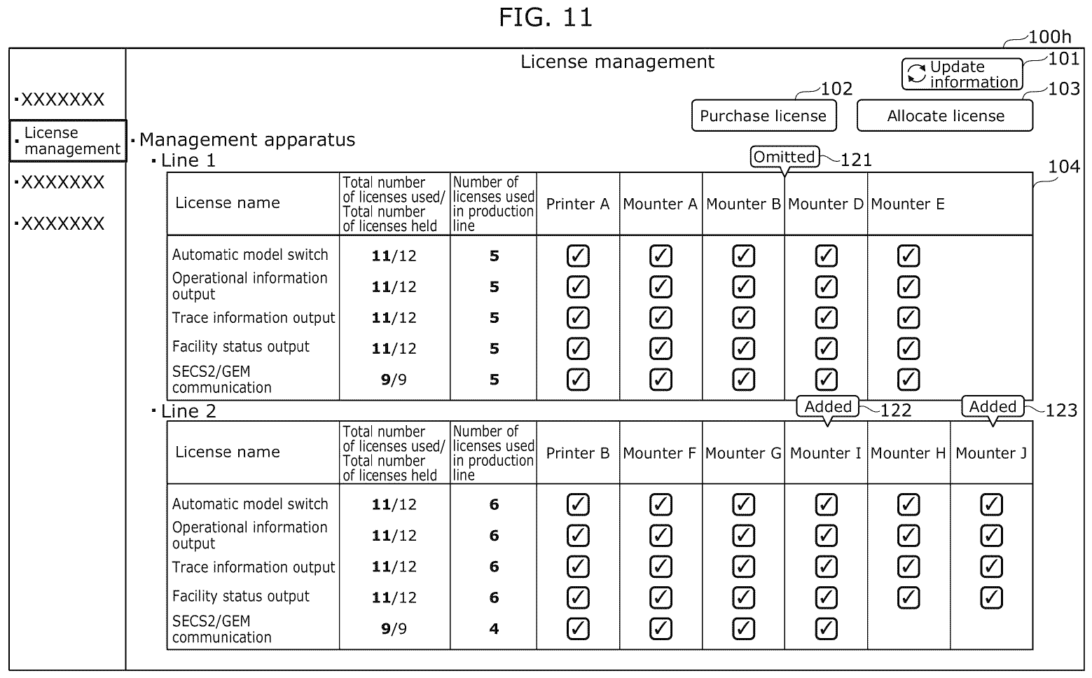

When production management apparatus 10 accepts an input to close button 161 in UI 100g, UI 160 in UI 100g disappears, and the UI is updated to UI 100h in which box 130 has been modified to purchase button 102 and allocation button 103, as illustrated in FIG. 11.

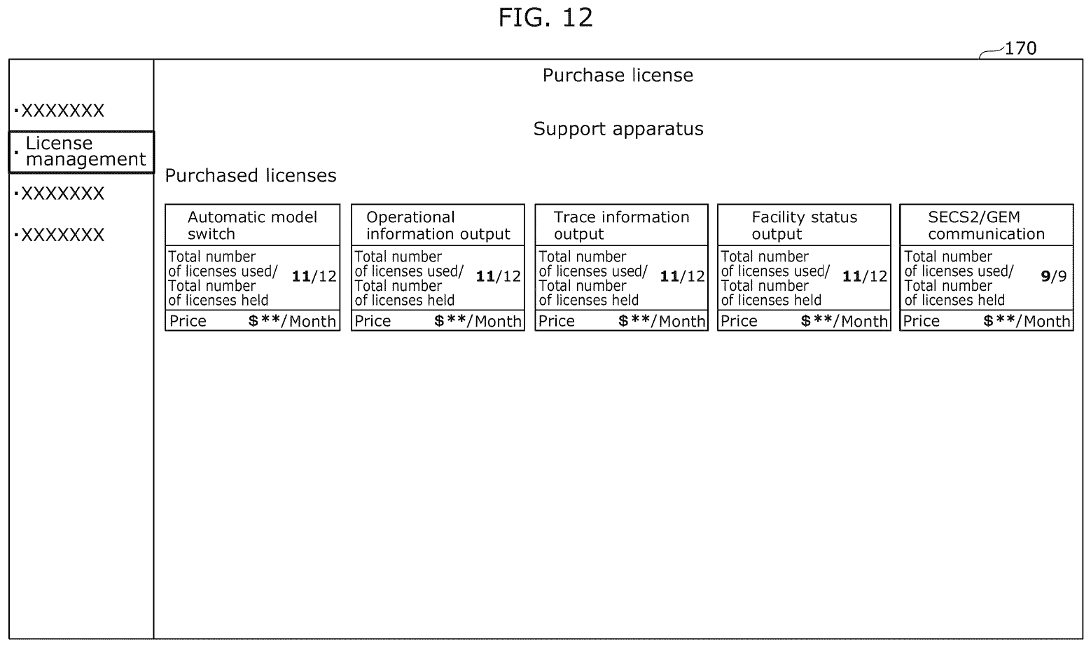

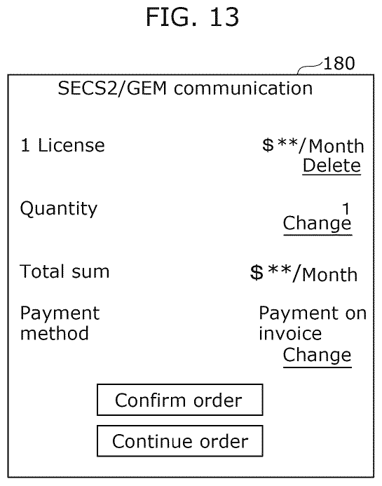

When production management apparatus 10 accepts an input to purchase button 102 in UI 100, UI 100b, or UI 100h, the UI transitions to UI 170, which is a purchasing screen for purchasing software licenses, as illustrated in FIG. 12. UI 100, UI 100b, and UI 100h are examples of a first UI, and purchase button 102 is an example of a button for accepting a control operation to transition to a purchasing screen for purchasing a software license. In UI 170, software licenses that correspond to software for automatic model switch, operational information output, trace information output, facility status output, and SECS/GEM communication can be additionally purchased. When inputs are made in the boxes that correspond to the various types of software licenses in UI 170, the Ui transitions to UI 180 for purchasing the corresponding types of software licenses, as illustrated in FIG. 13. FIG. 13 illustrates an example of the purchasing screen for purchasing a software license that corresponds to software for SECS/GEM communication, and illustrates that one software license is purchased.

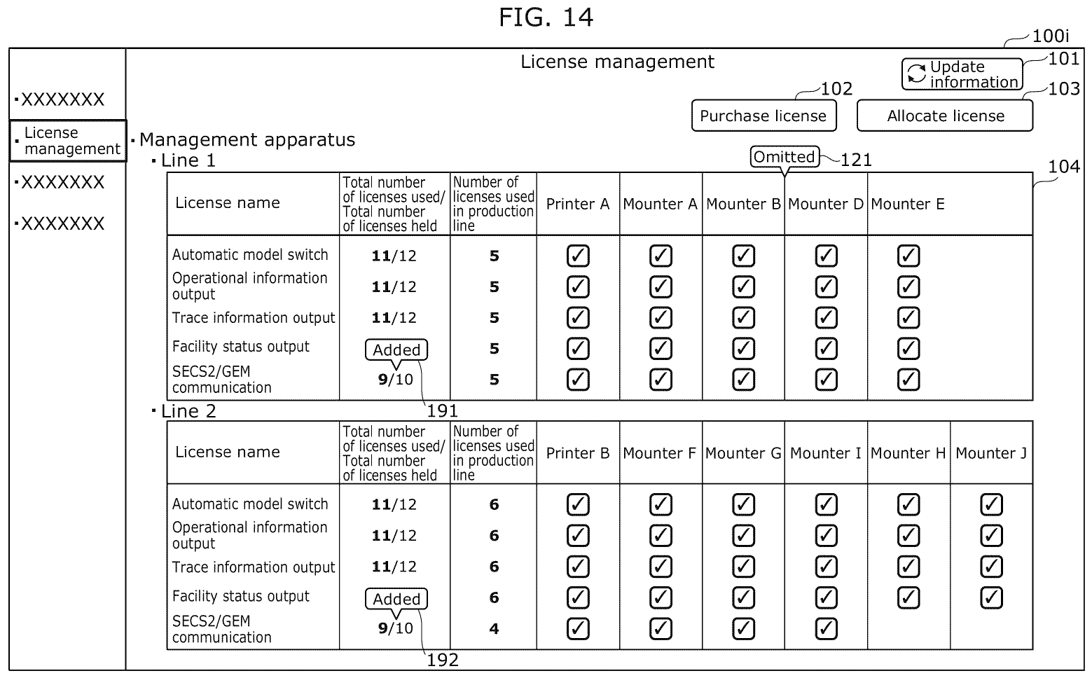

When the purchase of one software license that corresponds to software for SECS/GEM communication is completed in UI 180, the number of software licenses that correspond to the software for SECS/GEM communication increases by one. Therefore, as illustrated in FIG. 14, the total number of licenses used/total number of licenses held for SECS/GEM communication in UI 100h is updated from “9/9” to “9/10”. That is, the UI displayed on displayer 13 is updated from UI 100h to UI 100i. UI 100i may include icons 191 and 192 that indicate that the total number of licenses held for SECS/GEM communication has been added to.

### [3. Operation]

Next, the software license allocation process performed by production management apparatus 10 will be described.

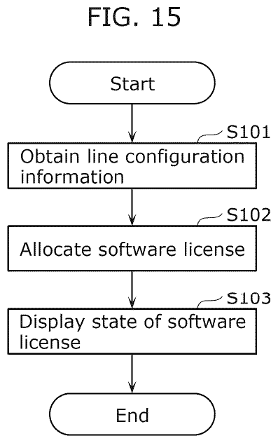

FIG. 15 is a flowchart illustrating an example of a software license allocation performed by the production management apparatus.

Production management apparatus 10 obtains line configuration information related to the apparatus configuration of production line L including production apparatuses M1 to M9 used in the production of mounting substrates (S101).

Next, production management apparatus 10 allocates, to production apparatuses M1 to M9, based on the line configuration information, software licenses that (i) correspond to a plurality of software which, by being executed, realize operations set to production apparatuses M1 to M9, and (ii) are used to permit execution of the plurality of software by production apparatuses M1 to M9 (S102).

Next, production management apparatus 10 displays the states of the software licenses allocated to production apparatuses M1 to M9 (S103). [4. Advantageous effects, etc.]

Production management system 1 according to the present embodiment includes obtainer 11, allocator 12, and displayer 13. Obtainer 11 obtains line configuration information related to an apparatus configuration of production line L including production-related apparatuses (production apparatuses M1 to M9, production management apparatus 10, or line management apparatus 20) used in production of a mounting substrate. Allocator 12 allocates, to the production-related apparatuses, based on the line configuration information, software licenses that correspond to a plurality of software which, by being executed, realize operations set to the production-related apparatuses, the software licenses being used to permit execution of the plurality of software by the production-related apparatuses. Displayer 13 displays a state of the software licenses allocated to the production-related apparatuses.

Accordingly, since the software licenses are allocated to the production-related apparatuses included in production line L based on the line configuration information of production line L, even when the configuration of production line L is changed, software licenses can be allocated according to the changed configuration.

Production management system 1 according to the present embodiment further includes storage 15. Storage 15 stores software licenses held by a user of the production-related apparatuses. Allocator 12 allocates software licenses from among the software licenses stored in storage 15.

For this reason, software licenses that are stored in advance can be allotted to the production-related apparatuses.

In production management system 1 according to the present embodiment, displayer 13 displays the software licenses allocated to the production-related apparatuses.

For this reason, the allocated software licenses can be presented to the user.

In production management system 1 according to the present embodiment, displayer 13 displays a total number of the software licenses held by the user of the production-related apparatuses and a total number of the software licenses allocated to the production-related apparatuses.

For this reason, the number of software licenses held by the user and the number of software licenses allocated to the production-related apparatuses can be presented to the user.

In production management system 1 according to the present embodiment, in response to an update to the production line, obtainer 11 obtains new line configuration information of the production line updated. Allocator 12 allocates, to a production-related apparatus added as a result of the update, based on the new line configuration information, a software license that has not been allocated to the production-related apparatuses among the software licenses held by the user of the production-related apparatuses.

For this reason, a software license that has not been allocated can be easily by allocated to an added production-related apparatus.

In production management system 1 according to the present embodiment, when software licenses for allocation to the production-related apparatuses are lacking in number, displayer 13 displays information indicating that the software licenses are lacking in number.

For this reason, the fact that software licenses are lacking can be presented to the user.

In production management system 1 according to the present embodiment, allocator 12 calculates, from the new line configuration information, a total number of software licenses that are lacking for allocation to the production-related apparatuses included in the production line updated. Displayer 13 displays the total number of software licenses that are lacking.

For this reason, the number software licenses that are lacking can be presented to the user.

In production management system 1 according to the present embodiment, displayer 13 displays a first user interface (UI) including a button for accepting a control operation to transition to a purchasing screen for purchasing a software license.

For this reason, the user can be prompted to perform a control operation to transition to a purchasing screen for purchasing a software license.

In production management system 1 according to the present embodiment, storage 15 stores a total number of licenses purchased via the purchasing screen.

For this reason, management according to the number of software licenses purchased can be performed. For example, the number of software licenses purchased can be added to the number of software licenses that have not been allocated.

In production management system 1 according to the present embodiment, in response to an update to the production line, obtainer 11 obtains new line configuration information of the production line updated. Allocator 12 cancels, based on the new line configuration information, an allocation of a software license allocated to a production-related apparatus removed from the production line as a result of the update.

For this reason, processing according to the cancellation of the allocation of a software license allocated to a production-related apparatus that has been removed can be easily performed. For example, the number of software licenses whose allocation has been cancelled can be added to the number of software licenses that have not been allocated.

In production management system 1 according to the present embodiment, allocator 12 calculates, based on a total number of software licenses that are lacking for allocation to the production-related apparatuses and a purchasing price associated with the software licenses that are lacking, a shortage amount relative to a payable balance of a user of the production-related apparatuses. Displayer 13 displays the shortage amount.

Accordingly, since the shortage amount is calculated and presented, it is possible to present the additional fee that is required from the user when the lacking software licenses are to be purchased.

### 5. Variations

(1) In the embodiment described above, production management apparatus 10 includes obtainer 11, allocator 12, displayer 13, and storage 15. However, production management apparatus 10 is not limited to this, but may include obtainer 11, allocator 12, and storage 15. That is, displayer 13 may be included in an external apparatus, processing result from allocator 12 may be sent to the external apparatus, and the external apparatus may provide a display based on the processing result. In that case, production management apparatus 10 may be a server (computer) that is connected to the line management apparatus or production line L over a computer network, such as the Internet. In that case, the external apparatus may be a PC that has a displayer and an input acceptor. The external apparatus is communicatively connected to the line management apparatus.

(2) In the embodiment described above, an example has been described in which a software license is manually allocated to an added production apparatus. However, a software license may be automatically allocated to an added production apparatus. When a plurality of production apparatuses are added, production management apparatus 10 may allocate software licenses in the order of addition or may allocate software licenses in a predetermined order of preference. If the software licenses are lacking in number as a result of an allocation, production management apparatus 10 may calculate a price (purchasing price) required to purchase the lacking software licenses, calculate the difference between the purchasing price and the payable balance as a shortage amount when the purchasing price is more than the payable balance, and display the shortage amount. If the software licenses are not lacking in number as a result of an allocation, production management apparatus 10 may confirm the allocation. Furthermore, when the purchasing price for purchasing the lacking software licenses is equal to or less than the payable balance, the lacking software licenses may be automatically purchased, and the purchased software license may be allocated to a production apparatus that is scheduled to be allocated a software license.

### Others

It should be noted that, in the foregoing embodiments, each of the constituent elements may be implemented as dedicated hardware or may be realized by executing a software program suited to such constituent elements. Alternatively, the constituent elements may be implemented by a program executor such as a CPU or a processor reading out and executing the software program recorded in a recording medium such as a hard disk or a semiconductor memory. Here, the software for implementing the production management apparatus, the production management system, and so on, according to the foregoing embodiments are programs for causing a computer to execute each of the steps included in the flowcharts illustrated in the Drawings.

Moreover, the present disclosure also includes cases such as those described below.

(1) More specifically, each of the devices in the foregoing embodiments may be a computer system configured with, for example, a microprocessor, a ROM, a RAM, a hard disk unit, a display unit, a keyboard, and a mouse. The RAM or the hard disk unit stores a computer program. The microprocessor operates according to the computer program, so that each function of the devices is achieved. Here, the computer program includes a plurality of instruction codes indicating instructions to be given to the computer so as to achieve a specific function.

(2) Some or all of the constituent elements included in each of the devices in the foregoing embodiments may be realized as a single system large scale integration (LSI). The system LSI is a super multifunctional LSI manufactured by integrating a plurality of constituent elements onto a single chip. To be more specific, the system LSI is a computer system configured with a microprocessor, a ROM, and a RAM, for example. The RAM stores a computer program. The microprocessor operates according to the computer program, so that a function of the system LSI is achieved.

(3) Some or all of the constituent elements included in each of the devices described above may be implemented as an IC card or a standalone module that can be inserted into and removed from the corresponding device. The IC card or the module is a computer system configured with a microprocessor, a ROM, and a RAM, for example. The IC card or the module may include the aforementioned super multifunctional LSI. The microprocessor operates according to the computer program, so that a function of the IC card or the module is achieved. The IC card or the module may be tamper-resistant.

(4) The present disclosure may be the methods described above. Each of the methods may be a computer program causing a computer to execute the steps included in the method. Moreover, the present disclosure may be a digital signal of the computer program.

Moreover, the present disclosure may be the aforementioned computer program or digital signal recorded on a computer-readable recording medium, such as a flexible disk, a hard disk, a CD-ROM, an MO, a DVD, a DVD-ROM, a DVD-RAM, a Blu-ray (registered trademark) disc (BD), or a semiconductor memory. The present disclosure may also be the digital signal recorded on such a recording medium.

Furthermore, the present disclosure may be the aforementioned computer program or digital signal transmitted via a telecommunication line, a wireless or wired communication line, a network represented by the Internet, and data broadcasting.

Moreover, the present disclosure may be a computer system including a microprocessor and a memory. The memory may store the aforementioned computer program and the microprocessor may operate according to the computer program.

Furthermore, by transferring the recording medium having the aforementioned program or digital signal recorded thereon or by transferring the aforementioned program or digital signal via the aforementioned network or the like, the present disclosure may be implemented by a different independent computer system.

(5) Embodiments and variations described above may be combined.

### INDUSTRIAL APPLICABILITY

The present disclosure is useful as a production management system, or the like, capable of easily setting software licenses according to the apparatus configuration of a production line.

1. A production management system comprising:
an obtainer that obtains line configuration information related to an apparatus configuration of a production line including production-related apparatuses used in production of a mounting substrate;
an allocator that allocates, to the production-related apparatuses, based on the line configuration information, software licenses that correspond to a plurality of software which, by being executed, realize operations set to the production-related apparatuses, the software licenses being used to permit execution of the plurality of software by the production-related apparatuses; and
a displayer that displays a state of the software licenses allocated to the production-related apparatuses.

2. The production management system according to claim 1, further comprising:
a storage that stores software licenses held by a user of the production-related apparatuses, wherein
the allocator allocates software licenses from among the software licenses stored in the storage.

3. The production management system according to claim 2, wherein
the displayer displays the software licenses allocated to the production-related apparatuses.

4. The production management system according to claim 3, wherein
the displayer displays a total number of the software licenses held by the user of the production-related apparatuses and a total number of the software licenses allocated to the production-related apparatuses.

5. The production management system according to claim 3, wherein
in response to an update to the production line, the obtainer obtains new line configuration information of the production line updated, and
the allocator allocates, to a production-related apparatus added as a result of the update, based on the new line configuration information, a software license that has not been allocated to the production-related apparatuses among the software licenses held by the user of the production-related apparatuses.

6. The production management system according to claim 5, wherein
when software licenses for allocation to the production-related apparatuses are lacking in number, the displayer displays information indicating that the software licenses are lacking in number.

7. The production management system according to claim 5, wherein
the allocator calculates, from the new line configuration information, a total number of software licenses that are lacking for allocation to the production-related apparatuses included in the production line updated, and
the displayer displays the total number of software licenses that are lacking.

8. The production management system according to claim 5, wherein
the displayer displays a first user interface (UI) including a button for accepting a control operation to transition to a purchasing screen for purchasing a software license.

9. The production management system according to claim 8, wherein
the storage stores a total number of licenses purchased via the purchasing screen.

10. The production management system according to claim 3, wherein
in response to an update to the production line, the obtainer obtains new line configuration information of the production line updated, and
the allocator cancels, based on the new line configuration information, an allocation of a software license allocated to a production-related apparatus removed from the production line as a result of the update.

11. The production management system according to claim 1, wherein
the production-related apparatuses include any one of a solder printing apparatus that prints solder on a substrate, a component mounting apparatus that mounts a component on the substrate, an inspecting apparatus that inspects the substrate on which the solder has been printed or the substrate on which the component has been mounted, or a support apparatus that supports at least one apparatus among the solder printing apparatus, the component mounting apparatus, or the inspecting apparatus by managing the at least one apparatus or managing production preparation work for the at least one apparatus.

12. The production management system according to claim 1, wherein
the allocator calculates, based on a total number of software licenses that are lacking for allocation to the production-related apparatuses and a purchasing price associated with the software licenses that are lacking, a shortage amount relative to a payable balance of a user of the production-related apparatuses, and
the displayer displays the shortage amount.

13. A production management method comprising:
obtaining line configuration information related to an apparatus configuration of a production line including production-related apparatuses used in production of a mounting substrate; and
allocating, to the production-related apparatuses, based on the line configuration information, software licenses that correspond to a plurality of software which, by being executed, realize operations set to the production-related apparatuses, the software licenses being used to permit execution of the plurality of software by the production-related apparatuses.

14. A non-transitory computer-readable recording medium having recorded thereon a program for causing a computer to execute the production management method according to claim 13.

15. A production management system comprising:
a storage that stores software licenses that correspond to a plurality of software which, by being executed, realize operations set to production-related apparatuses used in production of a mounting substrate, the software licenses being used to permit execution of the plurality of software by the production-related apparatuses;
an obtainer that obtains line configuration information related to an apparatus configuration of a production line including the production-related apparatuses; and
an allocator that allocates the software licenses to the production-related apparatuses based on the line configuration information.
